(19) United States
(12) Patent Application Publication
(10) Pub. No.: US 2016/0193499 A1
(43) Pub. Date: Jul. 7, 2016

(54) EXERCISE GUIDE PROVIDING DEVICE AND METHOD

(71) Applicant: Samsung Electronics Co., Ltd., Gyeonggi-do (KR)

(72) Inventors: Jeong Yun KIM, Seoul (KR); Seok Hyun KIM, Gyeonggi-do (KR)

(21) Appl. No.: 14/977,794

(22) Filed: Dec. 22, 2015

(30) Foreign Application Priority Data
Jan. 6, 2015 (KR) 10-2015-0001288

(51) Int. Cl. A63B 24/00; G09B 19/00

(52) U.S. Cl. CPC A63B 24/0006; G09B 19/003; A63B 2024/0009

(57) ABSTRACT

An electronic device provides a user with exercise guide information. An example device includes a display, at least one sensor configured to obtain information for determining a user's exercise state, and at least one processor. The at least one processor presents via the display exercise information set in an exercise program, and outputs guide information for exercise based on a comparison between a reference state set in the exercise program and the exercise state. In various embodiments, the guide information may include an avatar representing a user, shown behind or ahead of a reference avatar associated with the reference state, and/or audio coaching information for keeping pace with the reference avatar.

### CLAIM OF PRIORITY

This application claims the benefit under 35 U.S.C. §119(a) of a Korean patent application filed on Jan. 6, 2015 in the Korean Intellectual Property Office and assigned Serial number 10-2015-0001288, the entire disclosure of which is hereby incorporated by reference.

### TECHNICAL FIELD

The present disclosure relates generally to a method and device for guiding or coaching a user in an exercise routine.

### BACKGROUND

Portable electronic devices have recently been provisioned with capability to monitor a user's motion of walking, jogging or climbing, and to provide measurement information to the user regarding such motion. For example, a user may measure an exercise distance or an exercise time using an electronic device or simply may utilize an electronic device to listen to music during exercise. An electronic device such as a smartphone, a smart watch, and an MP3 player may include various applications or functions for assisting a user's exercise.

Smartphones provide various applications (“apps”) and functions, and as the awareness of health has risen, various health-based applications are provided. However, when an app just provides a user with simple data on exercise performed, it is difficult for users to follow and track their performance if more complex exercise routines are desired.

Additionally, feedback that does not fit a situation or is repeated often may interfere with a user's exercise or increase risk factors and cause a user performing an exercise to feel unstable.

### SUMMARY

Accordingly, an aspect of the present disclosure is to provide an electronic device and an exercise guiding method and device for allowing a user to easily identify an exercise program and providing feedback to the user appropriate for a situation.

In accordance with an aspect of the present disclosure, an electronic device includes: at least one sensor configured to obtain information for determining a user's exercise state; a display; and at least one processor configured to present via the display exercise information set in an exercise program, and output guide information for exercise based on a comparison between a reference state set in the exercise program and the exercise state.

### BRIEF DESCRIPTION OF THE DRAWINGS

FIG. 1 is a diagram schematically illustrating an electronic device in a network environment according to an embodiment of the present disclosure.

FIG. 2A shows an example selection screen for selecting a particular exercise routine according to an embodiment of the present disclosure.

FIG. 2B shows an example screen of an exercise program preliminarily selected, according to an embodiment of the present disclosure.

FIG. 2C shows an example screen of an exercise program according to an embodiment of the present disclosure.

FIG. 3A shows an example guide information providing screen of an exercise program, according to an embodiment of the present disclosure.

FIG. 3B shows an example guide information providing screen of an exercise program, according to an embodiment of the present disclosure.

FIG. 3C shows an example guide information providing screen of an exercise program, according to an embodiment of the present disclosure.

FIG. 4A is an example illustrating a guide information providing screen for an exercise section according to an embodiment of the present disclosure.

FIG. 4B is an example illustrating a guide information providing screen for an exercise section according to an embodiment of the present disclosure.

FIG. 4C is an example illustrating a guide information providing screen for an exercise section according to an embodiment of the present disclosure.

FIG. 5 is a flow chart illustrating a feedback providing process for guide information provision according to an embodiment of the present disclosure.

FIG. 6 is a flow chart illustrating a process for providing guide information according to an embodiment of the present disclosure.

FIG. 7 is a block diagram of an electronic device according to an embodiment of the present disclosure.

### DETAILED DESCRIPTION

Hereinafter, various embodiments of the present disclosure are disclosed with reference to the accompanying drawings. However, this does not limit various embodiments of the present disclosure to a specific embodiment and it should be understood that the present disclosure covers all the modifications, equivalents, and/or alternatives of this disclosure provided they fall within the scope of the appended claims and their equivalents. With respect to the descriptions of the drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements.

For instance, the expression “A or B”, or “at least one of A or/and B” may indicate include A, B, or both A and B. For instance, the expression “A or B”, or “at least one of A or/and B” may indicate (1) at least one A, (2) at least one B, or (3) both at least one A and at least one B.

The terms such as “first”, “second”, and the like used herein may refer to modifying various different elements of various embodiments of the present disclosure, but do not limit the elements. For instance, “a first user device” and “a second user device” may indicate different users regardless of the order or the importance. For example, a first component may be referred to as a second component and vice versa without departing from the scope of the present disclosure.

In various embodiments of the present disclosure, it will be understood that when a component (for example, a first component) is referred to as being “(operatively or communicatively) coupled with/to” or “connected to” another component (for example, a second component), the component may be directly connected to the other component or connected through another component (for example, a third component). In various embodiments of the present disclosure, it will be understood that when a component (for example, a first component) is referred to as being “directly connected to” or “directly accessing” another component (for example, a second component), another component (for example, a third component) does not exist between the component (for example, the first component) and the other component (for example, the second component).

The expression “configured to” used herein may be interchangeably used with “suitable for”, “having the capacity to”, “designed to”, “adapted to”, “made to”, or “capable of” according to a situation, for example. The term “configured to” may not necessarily mean “specifically designed to” in terms of hardware. Instead, the expression “a device configured to” in some situations may mean that the device and another device or part are “capable of”. For example, “a processor configured to perform A, B, and C” in a phrase may mean a dedicated processor (for example, an embedded processor) for performing a corresponding operation or a generic-purpose processor (for example, a CPU or application processor) for performing corresponding operations by executing at least one software program stored in a memory device.

Terms used in various embodiments of the present disclosure are used to describe specific embodiments of the present disclosure, and are not intended to limit the scope of other embodiments. The terms of a singular form may include plural forms unless they have a clearly different meaning in the context. Otherwise indicated herein, all the terms used herein, which include technical or scientific terms, may have the same meaning that is generally understood by a person skilled in the art. In general, the terms defined in the dictionary should be considered to have the same meaning as the contextual meaning of the related art, and, unless clearly defined herein, should not be understood abnormally or as having an excessively formal meaning. In any case, terms defined in this specification cannot be interpreted in a manner which would exclude embodiments of the present disclosure.

Hereinafter, an electronic device according to various embodiments of the present disclosure will be described in more detail with reference to the accompanying drawings.

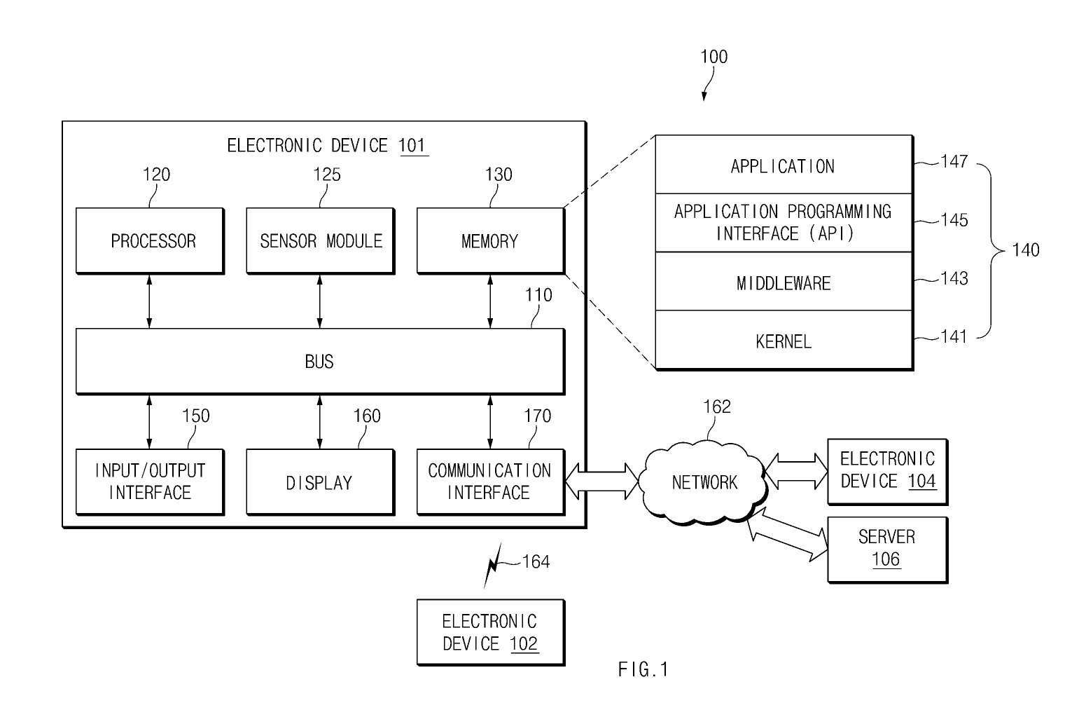

FIG. 1 is a diagram schematically illustrating an electronic device, 101, in a network environment 100 according to an embodiment of the present disclosure. Electronic device 101 may include a bus 110, a processor 120, a sensor module 125, a memory 130, an input/output interface 150, a display 160, and a communication interface 170. In other embodiments, device 101 may omit at least one of the components or may additionally include different component(s).

The bus 110, for example, may include a circuit for connecting the components 110 to 170 to each other and delivering a communication (for example, control message and/or data) between the components 110 to 170.

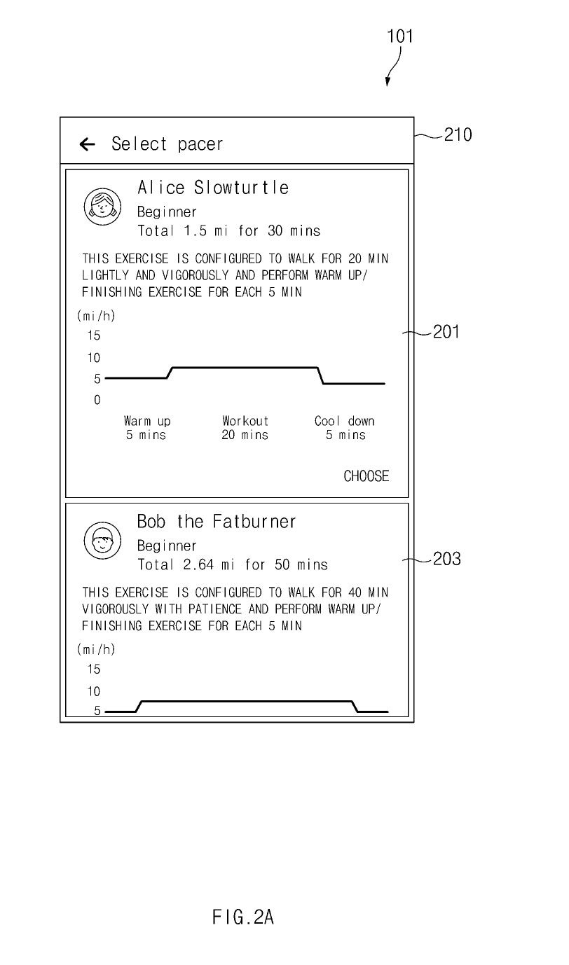

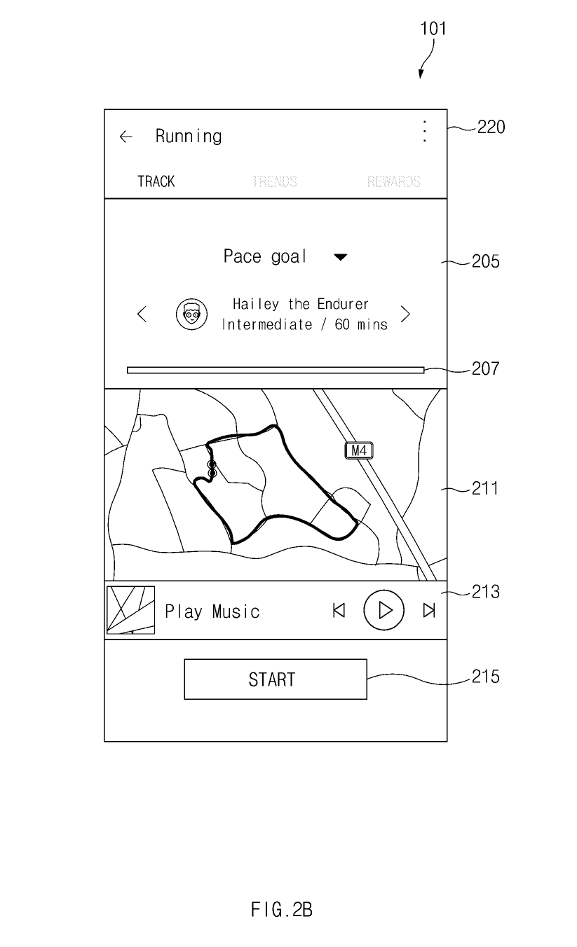

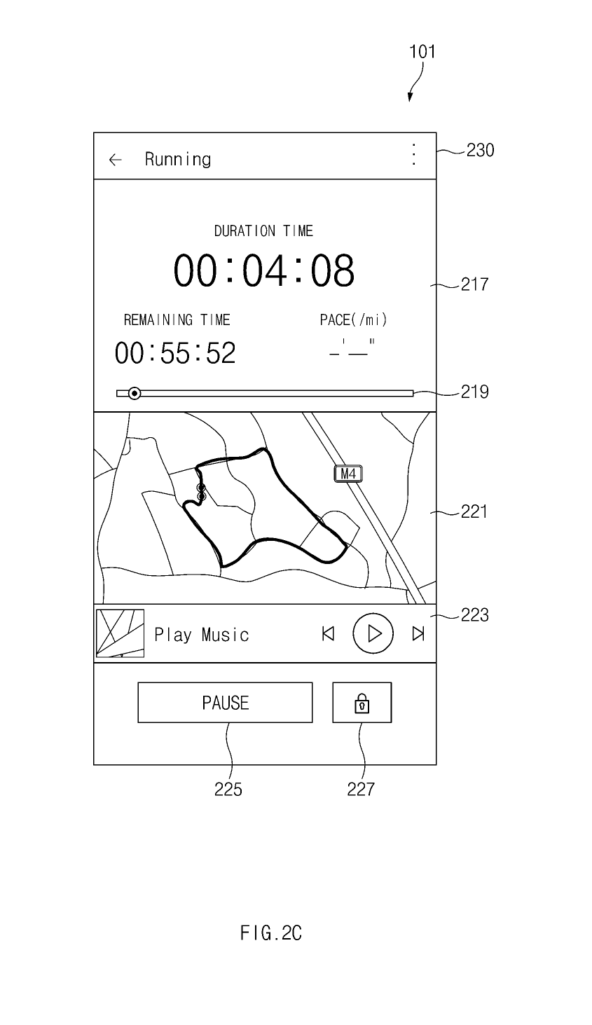

The processor 120 may include at least one of a central processing unit (CPU), an Application Processor (AP), and a communication processor (CP). The processor 120, for example, may execute calculation or data processing for control and/or communication of at least one another component of the electronic device 101. The processor 120 may execute an “exercise application (app)” (interchangeably, “exercise program” or “exercise application program”) retrieved from the memory 130 so as to carry out methods and processes described hereinbelow with reference to FIGS. 2A through 6.

The sensor module 125 may measure physical quantities or detect an operating state of the electronic device 101, thereby converting the measured or detected information into electrical signals. In particular, sensor module 125 may be configured to sense movement of a user carrying device 101, movement speed, and altitude. Sensor module 125 may also be configured to detect health parameters of a user such as heart rate. To this end, sensor module 125 may include at least one of a GPS receiver, a gyro sensor, a barometric pressure sensor, a magnetic sensor, an acceleration sensor, a biometric sensor, a temperature/humidity sensor, an illumination sensor, and an ultra violet (UV) sensor. Sensor module 125 may also include an E-nose sensor, an electromyography (EMG) sensor, an electroencephalogram (EEG) sensor, an electrocardiogram (ECG) sensor, an infra red (IR) sensor, an iris sensor, or a fingerprint sensor.

The memory 130 may include volatile and/or nonvolatile memory. The memory 130, for example, may store instructions or data relating to at least one another component of the electronic device 101. According to an embodiment of the present disclosure, the memory 130 may store software and/or program 140. The programs 140 may include a kernel 141, a middleware 143, an application programming interface (API) 145, and/or an application program (or an application) 147. At least part of the kernel 141, the middleware 143, or the API 145 may be called an operating system (OS).

The kernel 141, for example, may control or manage system resources (for example, the bus 110, the processor 120, the memory 130, and so on) used for performing operations or functions implemented in other programs (for example, the middleware 143, the API 145, or the application program 147). Additionally, the kernel 141 may provide an interface for controlling or managing system resources by accessing an individual component of the electronic device 101 from the middleware 143, the API 145, or the application program 147.

The middleware 143, for example, may serve as an intermediary role for exchanging data as the API 145 or the application program 147 communicates with the kernel 141.

Additionally, the middleware 143 may process at least one job request received from the application program 147 according to a priority. For example, the middleware 143 may assign to at least one application program 147 a priority for using a system resource (for example, the bus 110, the processor 120, or the memory 130) of the electronic device 101. For example, the middleware 143 may perform scheduling or load balancing on the at least one job request by processing the at least one job request according to the priority assigned to the at least one job request.

The API 145, as an interface for allowing the application program 147 to control a function provided from the kernel 141 or the middleware 143, may include at least one interface or function (for example, an instruction) for file control, window control, image processing, or character control.

The input/output interface 150, for example, may serve as an interface for delivering instructions or data inputted from a user or another external device to another component(s) of the electronic device 101. Additionally, the input/output interface 150 may output instructions or data received from another component(s) of the electronic device 101 to a user or another external device.

The display 160, for example, may include a liquid crystal display (LCD), a light emitting diode (LED) display, an organic light emitting diode (OLED) display, a microelectromechanical systems (MEMS) display, or an electronic paper display. The display 160 may display various content (for example, text, image, video, icon, symbol, and so on) to a user. The display 160 may include a touch screen, and for example, may receive a touch, gesture, proximity, or hovering input by using an electronic pen or a user's body part.

The communication interface 170, for example, may set a communication between the electronic device 101 and an external device (for example, the first external electronic device 102, the second external electronic device 104, or the server 106). For example, the communication interface 170 may communicate with an external device (for example, the second external electronic device 104 or the server 106) in connection to the network 162 through wireless communication or wired communication.

The wireless communication may use at least one of LTE, LTE-A, CDMA, WCDMA, UMTS, WiBro, or GSM as a cellular communication protocol, for example. Additionally, the wireless communication, for example, may include a short-range communication 164. The short range communication 164, for example, may include at least one of wireless fidelity (WiFi), Bluetooth (BT), near field communication (NFC), global positioning system (GPS), and so on. The wired communication, for example, may include at least one of universal serial bus (USB), high definition multimedia interface (HDMI), recommended standard 832 (RS-232), and plain old telephone service (POTS). The network 162 may include telecommunications network, for example, at least one of computer network (for example, LAN or WAN), internet, and telephone network.

Each of the first and second external electronic devices 102 and 104 may be the same or different type of device as device 101. Server 106 may include a group of one or more servers. All or part of operations executed on the device 101 may be executed on another one or more electronic devices (for example, the electronic device 102 or 104 or the server 106). When device 101 performs a certain function or service automatically or by a request, it may request at least part of a function relating thereto from another device (e.g. 102, 104 or 106) instead of or in addition to executing the function or service by itself. The other electronic device may execute a requested function or an additional function and may deliver an execution result to the electronic device 101. The electronic device 101 may provide the requested function or service as it is or by processing the received result additionally. For this, for example, cloud computing, distributed computing, or client-server computing technology may be used.

FIGS. 2A to 2C are example screens illustrating exercise program screens according to various embodiments.

FIG. 2A shows an example selection screen for selecting a particular exercise program. The electronic device 101 may display an initial screen 210 for selecting a suitable program from various exercise programs stored in the memory 130. When a healthcare application (for example, a commercially available app such as “S-health”) is selected by the user for execution or a connection between an external device and the electronic device 101 for exercise is established, a screen like 210 may be displayed on the display 160. For instance, if device 101 is a watch, a connection to an external base device like a smart phone may be wired or wireless, e.g., using Bluetooth. (The screens of FIGS. 2A-2C may be duplicated on the base device to allow for additional selection options.)

In conventional devices and apps providing exercise information, an app may just provide a user with simple data on an exercise goal and/or exercise performed, without aiding the user in achieving that goal. For example, a conventional app might only present information on objectives for exercise time and exercise distance, for example, 5 km running for 30 min. In this case, the user may be unaware that it is preferable to follow the exercise routine by running at different speeds for different sections of the routine. As another example, an exercise program may entail climbing for several hours in a particular climbing environment, but may fail to guide a user as to which portion of a climbing course is relatively easy or hard.

Referring still to FIG. 2A, a symbolic name may be assigned to a selectable exercise program on the screen, where the name may connote a type of the exercise program. Further, an exercise routine (also referred to occasionally as “exercise program”) may be divided into exercise sections, and an exercise method may be suggested according to each section. Thereby, a user may be apprised of an optimized way to complete the overall exercise routine. For example, an “Alice Slowturtle” exercise program 201 may provide a 1.5 mile 30 min walking program for a beginner. The exercise program 201 may be comprised of three sections—a warm up for 5 min, an exercise (walking) for 20 min, and a cool down for the last 5 min. Information on each exercise section is provided in a graph together with a simple description.

As mentioned above, unique exercise program names may be displayed to allow a user to easily select an appropriate exercise program from the general meaning associated with each name. For example, the “Alice Slowturtle” exercise program 201 may be an exercise program for a user who wants to start an exercise relatively slowly and lightly. A user may easily identify a good type of an exercise program to burn fat from the name of a “Bob the Fatburner” exercise program 203. A name like “Hailey the Endurer” (FIG. 2B) may provide an exercise program having an appropriate level for intermediate.

Once an arbitrary exercise program is selected, exercise information set for the selected program may be displayed. The exercise program may include a plurality of exercise sections. For example, a 60 min running program may include seven sections and each section may be set to a different running speed (e.g., 7 km/h, 10 km/h, and so on) or a different exercise state (e.g., warming up exercise, walking, running slowly, sprinting, and so on). In the example of screen 210, a graph showing different speeds as a function of exercise sections is shown each selectable exercise program.

FIG. 2B illustrates an example screen 220 for an exercise routine preliminarily selected from the screen 210. Screen 220 may display general information in an area 205 such as the name or target of a program. In an area 207 a progress bar may be displayed with color based on an exercise intensity for each exercise section. The progress bar, for example, may be displayed with darker color as an exercise intensity is stronger. For example, a section requiring running at 10 km/h may be displayed with darker color than a section requiring running at 7 km. If a course is sloped, a steeper slope on the course may be displayed with darker color than a gentle slope. A user may be apprised of the overall progress of an exercise program with the progress bar.

According to various embodiments, an exercise path pre-registered as part of a selected exercise program or set by a user may be displayed in the area 211 of the display 160. Alternatively, a map of a surrounding area based on the user's current location may be displayed in the area 211. Once an exercise starts, the electronic device 101 may determine the user's current location by using a GPS receiver or an acceleration sensor of sensor module 125, and display the user's current location on the map.

In the case of an exercise such as climbing in which changes in a user's altitude information is important, the electronic device 101 may obtain location information and altitude information through a sensor within sensor module 125 for measuring or estimating an altitude such as an altitude sensor or a barometer. In this case, a map for climbing including a climbing course may be outputted in the area 211.

In various embodiments, an area 213 may be designated as an area for secondary information that does not directly relate to an exercise program. For instance, information on music being played during an exercise and a control menu may be outputted in the area 213. A message (for example, SMS) received during an exercise may be outputted to the area 213. Area 213 may be also or alternatively be utilized as an area for outputting guide information provided during an exercise.

Once a start button 215 is selected, as a screen is switched, coaching for an exercise preset in the selected exercise program may start. For example, a screen shown in FIG. 2C may be provided.

The screen configurations shown in FIGS. 2A-2C are exemplary and may be modified variously. For example, the positions and forms of the areas 205, 207, 211, and 213 and the button 215 may be modified and also new areas may be added or some areas may be excluded according to a situation.

FIG. 2C is an example screen providing an exercise situation, e.g. monitoring and guiding, according to an embodiment of the present disclosure. Exercise information set in an exercise program may be displayed in areas 219 and 221, and information on a user's exercise state obtained through various sensors may be displayed in the area 217. For example, an elapsed time after starting an exercise (for example, after the start button of FIG. 2B is selected) and the remaining time (that is, an exercise time set in an exercise program minus the elapse time), and/or a user's exercise pace (for example, a running speed) may be output to the area 217. Additionally, a button 225 for pausing the exercise program and/or a screen lock button 227 for preventing the termination, stop, or change of the exercise program by an unintentional input may be additionally displayed.

An elapsed time of an exercise routine may be indicated on a progress bar 219. Based on a position displayed on the progress bar 219, a section representing an already elapsed time may be displayed with a color, e.g., gray, distinguished from the remaining portion. During an exercise, a user may visualize to what degree the current exercise has progressed and which sections still remain through an icon, e.g. the small circle, displayed on the progress bar 219. For example, if the next exercise section has a darker color than a current exercise section which is to the immediate left of the icon, a user may refine his or her breath or adjust the pace in preparation for the next exercise section in advance.

Appropriate exercise guide information may be set and stored in the memory 130 of the electronic device 101 according to each exercise program. For example, a 35 min exercise course could be comprised of first through fifth sections set in a running program for beginners as follows: a 5 min warm up exercise; running lightly (e.g. 6 km/h) for 10 min; running fast (e.g., 9 km/h) for 5 min; running lightly (e.g., 6 km/h) for 10 min; and a 5 min finishing exercise. Once the running program starts, a guide may be displayed for performing a warm up exercise for 5 min. When 5 min elapses, the electronic device 101 may provide guide information by comparing a user's exercise state and a reference state (for example, 6 km/h) set in the second section. For example, when a user is running at a speed that is less than a reference speed by a predetermined amount, e.g. 0.5 km/hr less than the reference speed, guide information suggesting that the user raise his pace may be output.

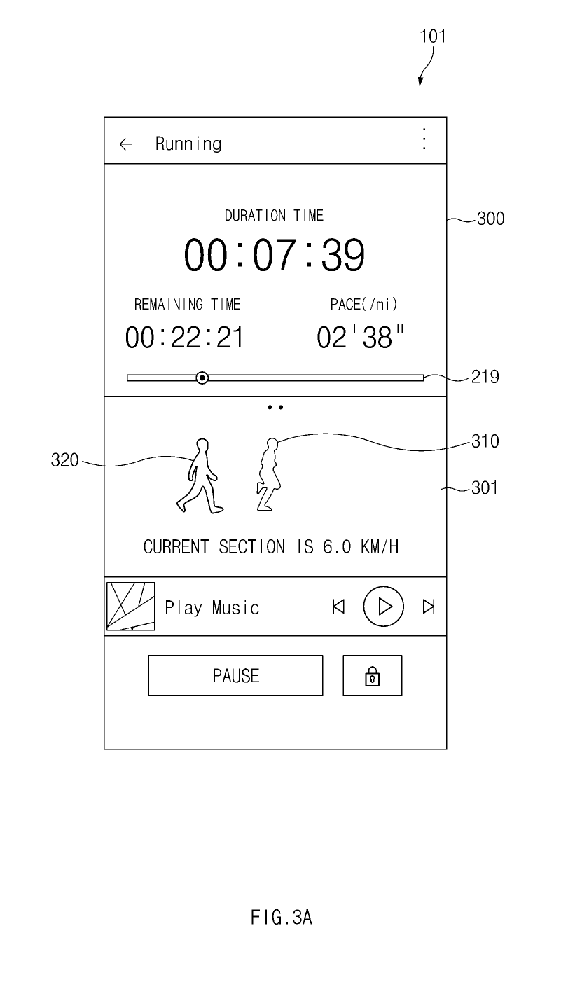

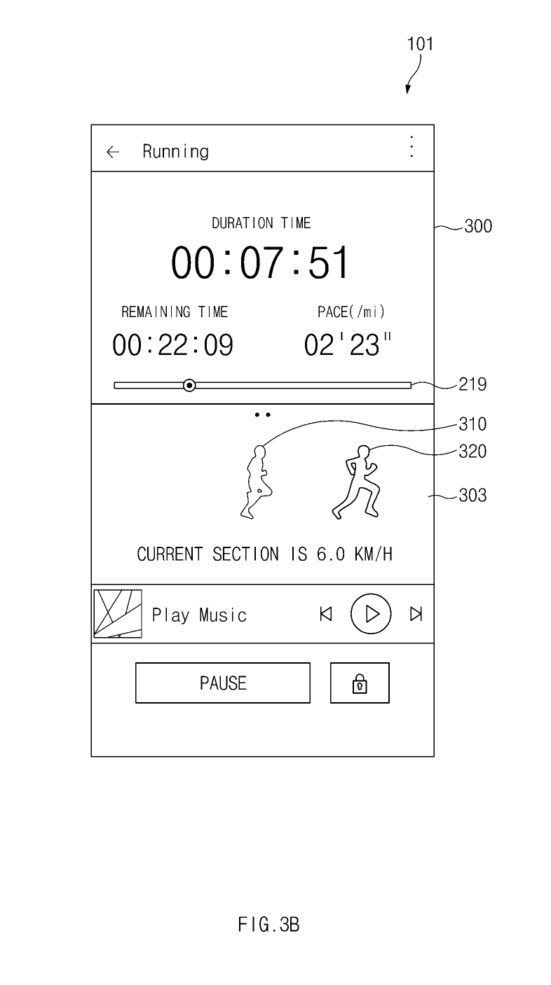

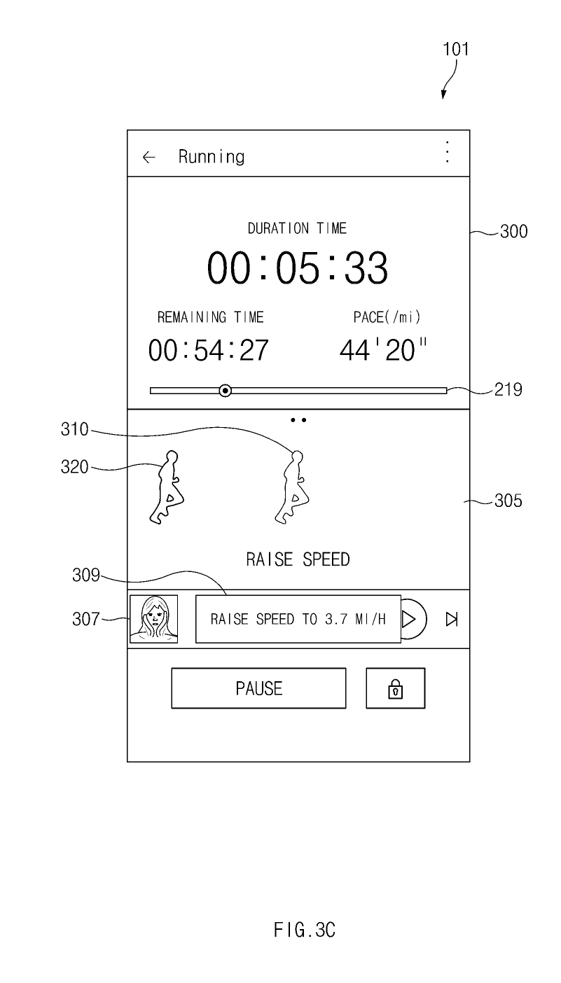

FIG. 3A is an example screen, 300, depicting guide information that informs a user of his or her progress relative to a reference state. Screen 300 in this example has a similar layout to that of FIG. 2C, but the map area 221 is replaced with a progress information area 301. A symbol 310 such as an avatar, representing a reference state of each section, such as a running speed or climbing rate, and a comparison result of a user's exercise state relative to the reference state may be output to area 301. Herein, such symbol representing a reference state of each section may be referred to as a “pacemaker”. Pacemaker 310 may be continually displayed at the center of area 301. That is, whether the current exercise section is a 6 km/h section or a 10 km/h section, the pacemaker 310 may always be disposed at the center of area 301. On the other hand, the position of a symbol 320 such as another avatar representing a user's exercise state may be determined by comparing the user's exercise state with the reference state. When a user exercises at a slower pace than a reference state for each section, as shown in FIG. 3A, the user's symbol 320 may be displayed to the rear of the pacemaker 310, e.g., the left side when the pacemaker is facing towards the right. On the other hand, when a user exercises at a faster pace than a reference state for the current section, as shown in FIG. 3B, a user's symbol may be displayed at the front of the pacemaker 310. (Another symbol or other type of information may be displayed to represent a cumulative performance of the user, i.e., for all sections of the exercise program which have elapsed, relative to an expected cumulative state of the exercise program.)

The user symbol 320 and pacemaker 310 may be output to the display 160 in real time. A user may check at what speed and at which location the user himself is running by viewing the user symbol 320's position relative to the pacemaker 310. A user may increase his or her pace to catch the pacemaker when the user symbol is behind the pacemaker and appropriately reduce a pace if desired when the user symbol is in front of the pacemaker.

Information on the current section (for example, “current 6.0 km/h section” displayed in the area 303 of FIG. 3B) besides coaching information (“raise speed” displayed in the area 305 of FIG. 3C) may be displayed on a User Interface (UI) continually by using the progress bar 219. Thus a user may check this through the display 160 during the course of exercise. However, since continually checking progress by looking at the display while running may increase the risk of accidents, an audio output guiding the user for pace may be provided. Device 101 may provide such audio output, e.g., a coaching comment, periodically or as necessary. For example, referring to FIG. 3C, the electronic device 101 may provide guide information 309 for pace (for example, “raise speed to 3.7 mi/h”) by displaying the same in a majority of the area 307, or a pop-up in area 307, and may also provide the same comment through an audio output.

For example, if a user's exercise state determined by the electronic device 101 does not correspond to a specified range for a corresponding section (for example, 6 km/h+/−0.5 km/h), the electronic device 101 may notify the user to adjust a pace. For example, if a reference speed is 6 km/h and a user exercises in a pace greater than 6.5 km/h or less than 5.5 km/h, the electronic device 101 may provide information coaching a user to raise or lower a pace through a display and/or an audio output.

Additionally, a user may check whether the displayed user symbol 320 is significantly behind or ahead of the pacemaker 310. When it is determined that a user reaches a reference state by adjusting a pace or exercises in a pace within a specified range with respect to the reference state, the electronic device 101 may provide a feedback (for example, “maintain this state”) for this condition. Such feedback may be provided through audio, thus apprising the user that he has returned to a normal pace without the need for monitoring the display.

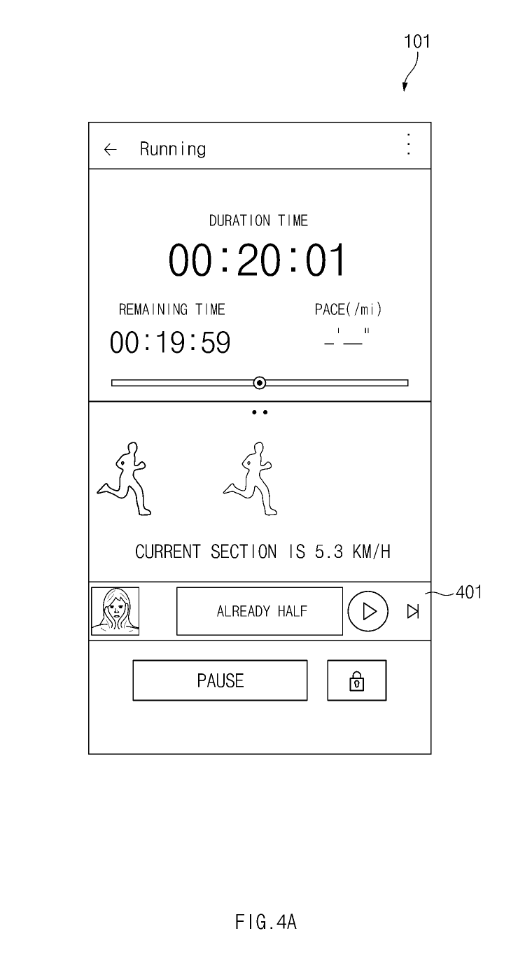

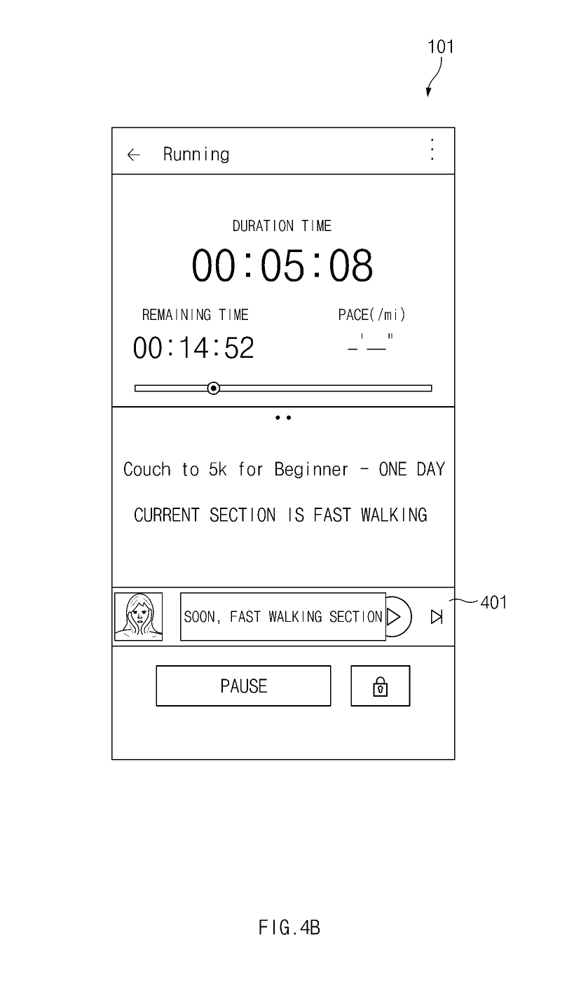

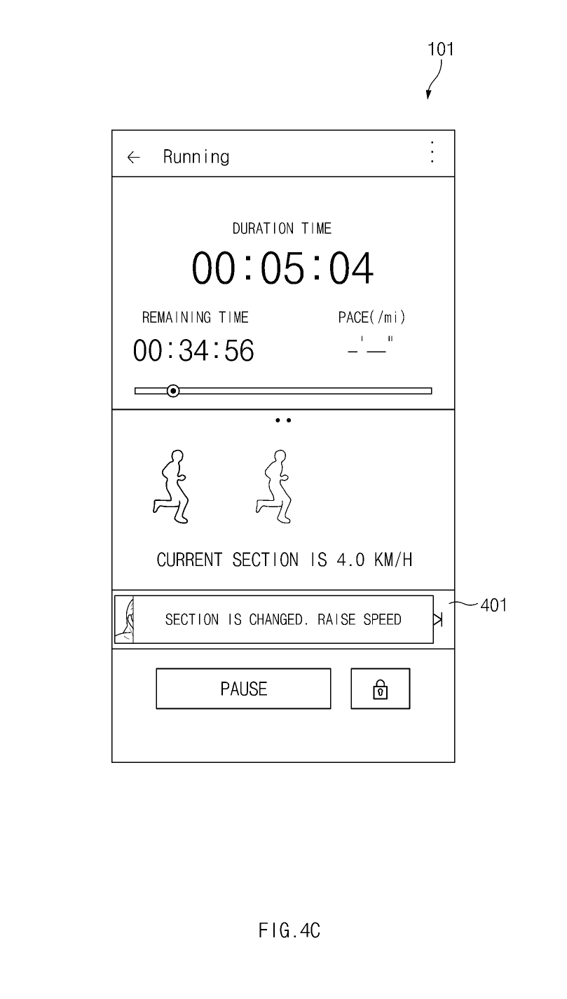

In addition to providing the above-discussed progress and coaching information, the electronic device 101 may provide guide information relating to a change of an exercise section. Embodiments relating to this will be described with reference to FIGS. 4A to 4C.

FIGS. 4A to 4C are views illustrating guide information providing screens for an exercise section according to an embodiment of the present disclosure.

FIG. 4A illustrates an exemplary screen where guide information is provided when a user passes a specified progress point along the entire exercise routine (which is comprised of multiple exercise sections). Here, the entire exercise routine may be defined as an entire exercise time set by an exercise program. Alternatively, the entire exercise routine may be defined by an entire exercise distance set by the exercise program. In another variant, calories and repetition counts set by an exercise program may define the entire exercise routine. Hereinafter, time will be mainly described as the measure of progress in completing the entire routine.

When the user's exercise progress passes a specified progress point (for example, 50%, 90%, or 100%) with respect to the entire exercise routine in the progress bar, the electronic device 101 may provide an appropriate guide. For example, when passing 20 min, which is the 50% point in the total 40 min exercise as shown in FIG. 4A, guide information such as “already reached half” may be displayed. Corresponding information may be displayed in the area 401 and may be additionally provided in a voice guide form through an audio output.

As mentioned above, the entire exercise routine may include a plurality of exercise sections. In the embodiment of FIG. 4A, an exercise section is not changed based on the 50% point (based on a point where guide is provided). For example, immediately before or after passing the 50% point, a user may exercise with the same intensity in an exercise section. Hereinafter, guide information provision relating to a section entry or a section change is described with reference to FIGS. 4B and 4C.

When an exercise program transitions from a first section to a second section, the electronic device 101 may allow a user to prepare for the next section by an advance alert that the second section is scheduled to begin shortly. For example, the electronic device 101 may allow a user to prepare by alerting the user of a walking or running section at a specific speed in advance with respect to each section in the exercise routine, in addition to a warm up exercise, a main exercise, and a finishing exercise. In the case of a climbing program, information on the slope or road condition (for example, gravel, or clay) of the next section may be provided in advance, and in the case of a cycle program, information on the road width, road surface, and curve course of the next section may be provided. For example, as shown in FIG. 4B, if a fast walking section starts after 6 min of an exercise start, information on the next section (for example, “soon, fast walking section”) may be provided before 1 min of the section entry point. Besides that, a comment such as “soon, main exercise starts” may be provided before entering a main exercise section from a warm up section. Further, information (for example, “soon, 2.5 mi/h section”) on a reference state of a corresponding section may be provided before transitioning to a section where the reference state is changed. If different types of information on the next section are to be provided as exemplified above, different time points may be set for the different respective types of information.

The above-mentioned embodiments may exemplarily provide voice guide and/or a display guide using pop-up, and information on a section change may be provided through notification sound or vibration.

When transitioning to a new exercise section, the electronic device 101 may provide reference state information related to the transition. For example, referring to FIG. 4C, when a user transitions to a 4.0 mi/h section, the electronic device 101 may provide reference state information (for example, “entering 4.0 mi/h section) of the current section and/or comparison information (for example, “raise speed”) of a reference state between the current section and a previous section.

In various embodiments, guide instructions for an exercise section may be output more frequently at the beginning of an exercise. For example, an entry guide, an exercise section change guide, and progress point guides, e.g., 10%, 25%, and 50% progress point guides for an exercise section may be displayed near the beginning of an entire exercise routine (or section). However, a user's physical strength may be relatively reduced in the second half of an exercise and many repeated notifications may cause annoyance to a user. Accordingly, an entry guide for exercise section may be excluded and only an exercise section change guide may be provided in the latter portion, e.g. second half of an exercise. Additionally, a repetition rate at which pace feedback is provided to the user may be relatively longer in the latter portion.

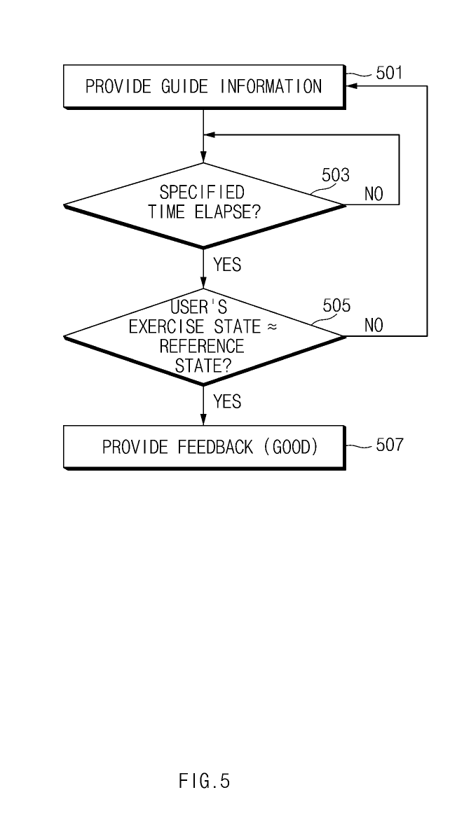

The electronic device 101 may check whether a user appropriately adjusts an exercise state with respect to various guide information provided to the user and may provide a feedback thereto. In relation to this, it will be described with a flowchart of FIG. 5.

FIG. 5 is a flowchart illustrating a feedback providing process for guide information provision according to an embodiment. The electronic device 101 may provide guide information in operation 501. Here, the guide information may correspond to all guide information in the various forms but according to some embodiments of the present disclosure, only guide information requiring feedback may correspond to the guide information described with reference to FIG. 5. For example, with respect to a guide provision for section change, feedback on whether a user exercises in correspondence to a changed section may be provided; however, when a notification for section entry is provided, since a user's exercise state is not required to be changed immediately, feedback may be withheld.

In operation 503, the electronic device 101 may determine whether a specified time elapses. For example, if a specified time is 7 sec and a guide provided in operation 501 is “raise speed to 10 km/h”, the electronic device 101 may wait until 7 sec elapses (while collecting information on a user's exercise state), and if 7 sec elapses, determine whether the current user's exercise state matches, within a tolerance, a reference state of a corresponding exercise section in operation 505.

When a user's exercise state matches the reference state in operation 505, that is, a user's exercise state is in an exercise state of an allowable level in comparison to a reference state, the electronic device 101 may provide a positive feedback (for example, “maintain this state !”) in operation 507. If a user's exercise state is too fast or too slow, i.e., outside the designated tolerance of the reference state, guide information may be provided (501). For example, feedback instructing the user to raise speed or lower speed may be provided.

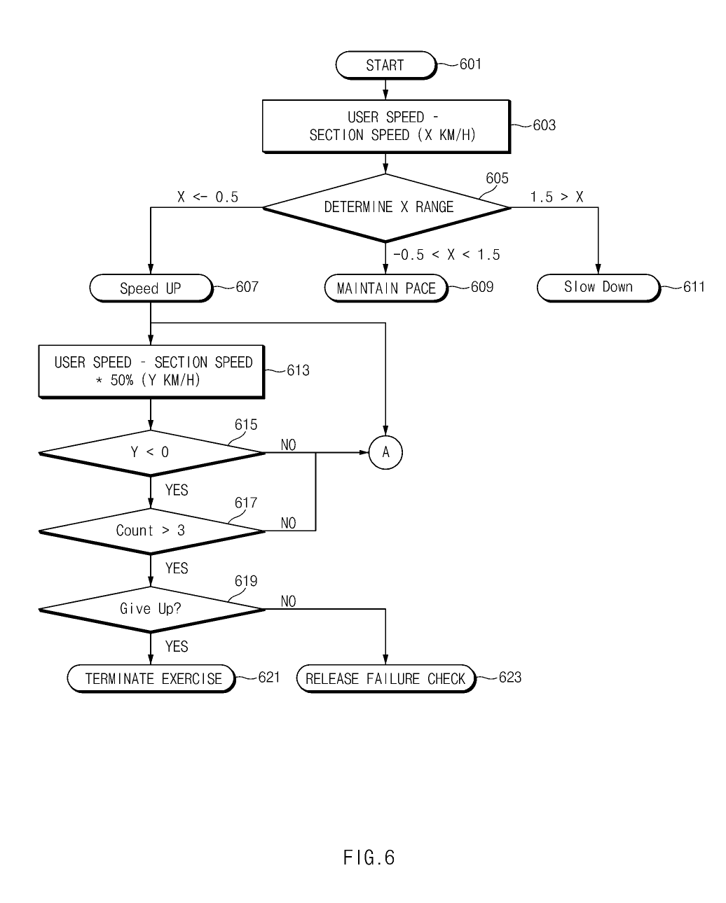

FIG. 6 is a flow chart illustrating a process for providing guide information according to an embodiment of the present disclosure. The process is exemplary and may be repeatedly performed according to a predetermined period. For example, operation 601 may signify the start of the process of FIG. 6, and the flow may return to operation 601 from any other stage of the process every 30 sec. Thereby, the overall process of FIG. 6 may operate repeatedly every 30 sec, corresponding to an “operating period”. With regard to the exercise application program setting a suitable operating period, various factors may be considered, and the operating period may be designed to change dynamically. For example, when music is being played by the electronic device 101, in order to reduce interference with music listening due to frequent feedback, an operating period may be increased (for example, to 60 sec). Music playing may be initiated or stopped during an exercise and an operating period of a process may be changed accordingly. Regardless of whether music is being played, an operating period may be set differently depending on a specific time point within the overall exercise routine. For instance, an operating period for the first half of the routine may be set at 30 sec while the period for the second half is set at 60 sec. In another example, an operating period may be set differently according to an exercise section specific exercise intensity. For instance, when an exercise intensity is high (e.g., a reference speed is fast or a user exercises in a steep course), the electronic device 101 may increase an operating period.

As discussed earlier, in addition to providing feedback on the user's exercise state relative to a reference state, the exercise application program may occasionally provide arbitrary guide information such as alerting the user of a progress point or a section change. In the process of FIG. 6, if such arbitrary guide information is provided, the operating period beginning at 601 may be initialized. For example, suppose the process is set to return to 601 in a 30 sec period, and another type of guide information (e.g., a guide for 50% point pass of the entire routine) is provided at the time point that 20 sec elapses after a previous operation started. In this case, an operating period beginning at 601 may start again at the time point that the other guide information is provided. Through this, a guide may be provided at an appropriate time point and period instead of continually providing coaching at a predetermined interval to a user. Further, provision may be available for a user to adjust the operating period via user command. A user may determine whether or not a guide is provided at an appropriate time point according to an elapsed time between a time point at which a previous guide is provided and a time point at which a new guide is provided.

In various embodiments, the operating period may be set in correspondence with the total length of an exercise program in execution; the progress point of the exercise program, such as early/mid/late; and an exercise intensity of an exercise section. An operating period may also be adjusted according to a user's exercise state information such as a user's heart rate obtained through a sensor.

Hereinafter, for convenience of description, the process of FIG. 6 is described by using an example that a user runs while guided with a running program.

In operation 603, the electronic device 101 may determine a user's speed by using a sensor and compare it with a reference speed of a corresponding exercise section. For example, the electronic device 101 may obtain an X km/h value corresponding to (user's speed−section speed).

In operation 605, the electronic device 101 may determine a range corresponding to the X value. For example, the electronic device 101 may identify a range of the X value according to (1) X is less than −0.5, (2) X is between −0.5 and 1.5, and (3) X is greater than 1.5. That is, the electronic device 101 may determine (1) a case that a user is running at a speed that is 0.5 km/h slower than a reference speed, (2) a case that a user is running at a speed that is similar to a reference speed or faster slightly (up to 1.5 km/h faster), and (3) a case that a user is running at a speed that is more than 1.5 km/h faster.

In the case of (1), the electronic device 101 may provide a feedback coaching the user to increase speed in operation 607. After operation 607, an additional process to determine whether the user is significantly behind the reference rate may be performed, as described later.

In the case of (2), the electronic device 101 may provide feedback coaching the user to maintain the current pace in operation 609. In the case of (3), the electronic device 101 may provide a feedback suggesting that the user reduce speed when a pace is too fast in operation 611. Although not shown in the drawing, after providing the feedback of operation 611, in order to determine whether a user lowers speed to an appropriate level, a feedback check process (for example, operation 501 to operation 507) shown in FIG. 5 may be performed. The process of FIG. 5 may be referred to as operation 614 of FIG. 6.

Following operation 607, the process flow may proceed to operation 614 in order to check whether a user increases speed appropriately after the feedback is provided. Separately or simultaneously, it may be determined whether a user's speed does not reach 50% of the reference speed for the section. In operation 613, the electronic device 101 may obtain a value “Y” in km/h which is a measure of the user's speed relative to 50% of the reference speed. That is, Y equals (user's speed−section speed*50%). The value 50% of a section speed is exemplary and another percentage value may be set according to a program.

In operation 615, it is determined whether the Y value is negative. That is, the electronic device 101 may determine whether a user's speed is below 50% of a section speed. If the user's speed is more than 50% of the section speed, the feedback check process 614 may be performed.

If the user's speed is below 50% of the section speed at 615, it may be determined whether this situation occurs more than a specified number of times, e.g., three times, during program execution. If not, the feedback check process at 614 may be performed. If the situation is found to have occurred the specified number of times, the electronic device 101 may check whether a user gives up an exercise in operation 619. A corresponding message may be provided in pop-up or Text-To-Speech (TTS) or may be provided using both methods. When a user provides a response indicating he has given up, the electronic device 101 may terminate the exercise program in operation 621. When a user provides a response indicating not giving up, the electronic device 101 may release a failure check in operation 623. In this case, the feedback check process of operation 614 may be performed. Additionally, after operation 623, a count value determined in operation 617 may be increased by 1. If the count value is increased more than another threshold (for example, five times) in operation 623 as a result of the increase of the count value, when operation 617 is performed in the process of the next period, the electronic device 101 may terminate the exercise program and provide a failure message regardless of a user's intention.

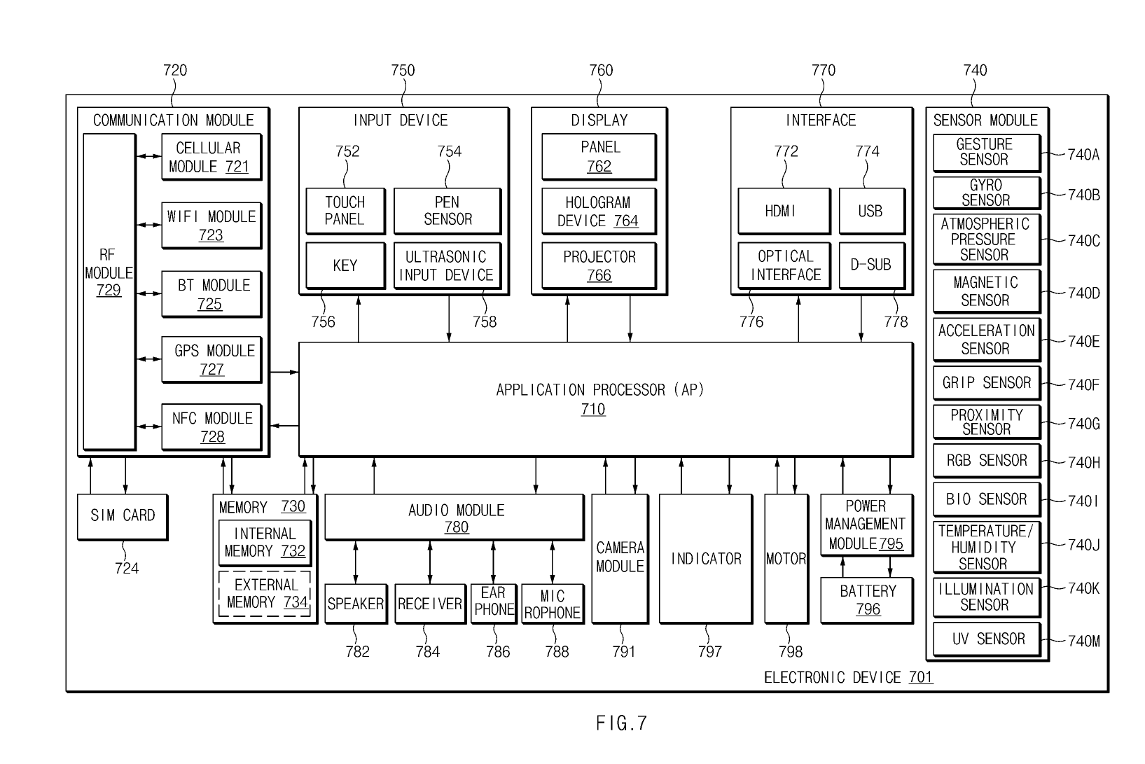

FIG. 7 is a block diagram of an electronic device, 701, according to an embodiment of the present disclosure. Electronic device 701, for example, may configure all or part of the above-discussed electronic device 101 shown in FIG. 1. The electronic device 701 may include at least one processor (for example, an application processor (AP) 710), a communication module 720, a subscriber identification module (SIM) 724, a memory 730, a sensor module 740, an input device 750, a display 760, an interface 770, an audio module 780, a camera module 791, a power management module 795, a battery 796, an indicator 797, and a motor 798.

The processor 710 may control a plurality of hardware or software components connected thereto and also may perform various data processing and operations by executing an operating system or an application program. The processor 710 may be implemented with a system on chip (SoC), for example. According to an embodiment of the present disclosure, the processor 710 may further include a graphic processing unit (GPU) (not shown) and/or an image signal processor. The processor 710 may include at least part (for example, the cellular module 721) of components shown in FIG. 7. The processor 710 may load commands or data received from at least one of other components (for example, nonvolatile memory) and process them and may store various data in a nonvolatile memory.

The communication module 720 may have the same or similar configuration to the communication interface 170 of FIG. 1. The communication module 720 may include a cellular module 721, a WiFi module 723, a BT module 725, a GPS module 727, an NFC module 728, and a radio frequency (RF) module 729.

The cellular module 721, for example, may provide voice call, video call, text service, or internet service through communication network. According to an embodiment of the present disclosure, the cellular module 721 may perform a distinction and authentication operation on the electronic device 701 in a communication network by using a SIM (for example, a SIM card) 724. According to an embodiment of the present disclosure, the cellular module 721 may perform at least part of a function that the processor 710 provides. According to an embodiment of the present disclosure, the cellular module 721 may further include a communication processor (CP).

Each of the WiFi module 723, the BT module 725, the GPS module 727, and the NFC module 728 may include a processor for processing data transmitted/received through a corresponding module. According to an embodiment of the present disclosure, at least part (for example, at least one) of the cellular module 721, the WiFi module 723, the BT module 725, the GPS module 727, and the NFC module 728 may be included in one integrated chip (IC) or IC package.

The RF module 729, for example, may transmit/receive communication signals (for example, RF signals). The RF module 729, for example, may include a transceiver, a power amp module (PAM), a frequency filter, a low noise amplifier (LNA), or an antenna. According to another embodiment of the present disclosure, at least one of the cellular module 721, the WiFi module 723, the Bluetooth module 725, the GPS module 727, and the NFC module 728 may transmit/receive RF signals through a separate RF module.

The SIM 724, for example, may include a card including a SIM and/or an embedded SIM and also may include unique identification information (for example, an integrated circuit card identifier (ICCID)) or subscriber information (for example, an international mobile subscriber identity (IMSI)).

The memory 730 (for example, the memory 130) may include an internal memory 732 or an external memory 734. The internal memory 732 may include at least one of a volatile memory (for example, dynamic RAM (DRAM), static RAM (SRAM), synchronous dynamic RAM (SDRAM)) and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash memory or NOR flash memory), hard drive, or solid state drive (SSD)).

The external memory 734 may further include flash drive, for example, compact flash (CF), secure digital (SD), micro Micro-SD, Mini-SD, extreme digital (xD), (MultiMediaCard (MMC), or a memorystick. The external memory 734 may be functionally and/or physically connected to the electronic device 701 through various interfaces.

The sensor module 740 (an example of sensor module 125) measures physical quantities or detects an operating state of the electronic device 701, thereby converting the measured or detected information into electrical signals. The sensor module 740 may include at least one of a gesture sensor 740A, a gyro sensor 740B, a barometric pressure sensor 740C, a magnetic sensor 740D, an acceleration sensor 740E, a grip sensor 740F, a proximity sensor 740G, a color sensor 740H (for example, a red, green, blue (RGB) sensor), a biometric sensor 740I, a temperature/humidity sensor 740J, an illumination sensor 740K, and an ultra violet (UV) sensor 740M. Additionally or alternatively, the sensor module 740 may include an E-nose sensor, an electromyography (EMG) sensor, an electroencephalogram (EEG) sensor, an electrocardiogram (ECG) sensor, an infra red (IR) sensor, an iris sensor, or a fingerprint sensor. The sensor module 740 may further include a control circuit for controlling at least one sensor therein. According to an embodiment of the present disclosure, the electronic device 701 may further include a processor configured to control the sensor module 740 as part of or separately from the processor 710 and thus may control the sensor module 740 while the processor 710 is in a sleep state.

The input device 750 may include a touch panel 752, a (digital) pen sensor 754, a key 756, or an ultrasonic input device 758. The touch panel 752 may use at least one of capacitive, resistive, infrared, or ultrasonic methods, for example. Additionally, the touch panel 752 may further include a control circuit. The touch panel 752 may further include a tactile layer to provide tactile response to a user.

The (digital) pen sensor 754, for example, may include a sheet for recognition as part of a touch panel or a separate sheet for recognition. The key 756 may include a physical button, an optical key, or a keypad, for example. The ultrasonic input device 758 may detect ultrasonic waves generated from an input tool through a microphone (for example, the microphone 788) in order to check data corresponding to the detected ultrasonic waves.

The display 760 (for example, the display 160) may include a panel 762, a hologram device 764, or a projector 766. The panel 762 may have the same or similar configuration to the display 160 of FIG. 1. The panel 762 may be implemented to be flexible, transparent, or wearable, for example. The panel 762 and the touch panel 752 may be configured with one module. The hologram 764 may show three-dimensional images in the air by using the interference of light. The projector 766 may display an image by projecting light on a screen. The screen, for example, may be placed inside or outside the electronic device 701. According to an embodiment of the present disclosure, the display 760 may further include a control circuit for controlling the panel 762, the hologram device 764, or the projector 766.

The interface 770 may include a high-definition multimedia interface (HDMI) 772, a universal serial bus (USB) 774, an optical interface 776, or a D-subminiature (sub) 778, for example. The interface 770, for example, may be included in the communication interface 170 shown in FIG. 1. Additionally or alternatively, the interface 770 may include a mobile high-definition link (MHL) interface, a secure Digital (SD) card/multi-media card (MMC) interface, or an infrared data association (IrDA) standard interface.

The audio module 780 may convert sound into electrical signals and convert electrical signals into sounds. At least some components of the audio module 780, for example, may be included in the input/output interface 150 shown in FIG. 1. The audio module 780 may process sound information inputted/outputted through a speaker 782, a receiver 784, an earphone 786, or a microphone 788.

The camera module 791, as a device for capturing a still image and a video, may include at least one image sensor (for example, a front sensor or a rear sensor), a lens (not shown), an image signal processor (ISP) (not shown), or a flash (not shown) (for example, an LED or a xenon lamp).

The power management module 795 may manage the power of the electronic device 701. According to an embodiment of the present disclosure, the power management module 795 may include a power management IC (PMIC), a charger IC, or a battery or fuel gauge, for example. The PMIC may have a wired and/or wireless charging method. As the wireless charging method, for example, there is a magnetic resonance method, a magnetic induction method, or an electromagnetic method. An additional circuit for wireless charging, for example, a circuit such as a coil loop, a resonant circuit, or a rectifier circuit, may be added. The battery gauge may measure the remaining amount of the battery 796, or a voltage, current, or temperature thereof during charging. The battery 796, for example, may include a rechargeable battery and/or a solar battery.

The indicator 797 may display a specific state of the electronic device 701 or part thereof (for example, the processor 710), for example, a booting state, a message state, or a charging state. The motor 798 may convert electrical signals into mechanical vibration and may generate vibration or haptic effect. Although not shown in the drawings, the electronic device 701 may include a processing device (for example, a GPU) for mobile TV support. A processing device for mobile TV support may process media data according to the standards such as digital multimedia broadcasting (DMB), digital video broadcasting (DVB), or mediaFLO™.

According to various embodiments disclosed in this specification, a user of an electronic device may select a program appropriate for himself/herself from the name of an exercise program and may easily identify a configuration of the exercise program. Additionally, an effective exercise method may be determined through a “pacemaker” provided in real time and an (audio) feedback provided at an appropriate time point while an exercise program is executed.

Each of the above-mentioned components of the electronic device according to various embodiments of the present disclosure may be configured with at least one component and the name of a corresponding component may vary according to the kind of an electronic device. According to various embodiments of the present disclosure, an electronic device according to various embodiments of the present disclosure may include at least one of the above-mentioned components, may not include some of the above-mentioned components, or may further include another component. Additionally, some of components in an electronic device according to various embodiments of the present disclosure are configured as one entity, so that functions of previous corresponding components are performed identically.

The term “module” used in various embodiments of the present disclosure, for example, may mean a unit including a combination of at least one of hardware, software, and firmware. The term “module” and the term “unit”, “logic”, “logical block”, “component”, or “circuit” may be interchangeably used. A “module” may be a minimum unit or part of an integrally configured component. A “module” may be a minimum unit performing at least one function or part thereof. A “module” may be implemented mechanically or electronically. For example, “module” according to various embodiments of the present disclosure may include at least one of an application-specific integrated circuit (ASIC) chip performing certain operations, field-programmable gate arrays (FPGAs), or a programmable-logic device, all of which are known or to be developed in the future.

According to various embodiments of the present disclosure, at least part of a device (for example, modules or functions thereof) or a method (for example, operations) according to this disclosure, for example, as in a form of a programming module, may be implemented using an instruction stored in computer-readable storage media.

For example, the storage medium may store instructions to allow a processor of an electronic device to execute obtaining information for determining a user's exercise state by using at least one sensor, outputting, to a display, exercise information set in an exercise program and the obtained information, and providing guide information by comparing a reference state set in the exercise program and the exercise state. Moreover, the storage medium may store instructions to perform the various methods mentioned in the above embodiments of the present disclosure. For example, in relation to the performing of the guide information, the storage medium may include instructions to execute outputting a first symbol corresponding to the reference state to the display and outputting a second symbol corresponding to the exercise state to a relative position with respect to the first symbol based on the comparison result.

A module or a programming module according to various embodiments of the present disclosure may include at least one of the above-mentioned components, may not include some of the above-mentioned components, or may further include another component. Operations performed by a module, a programming module, or other components according to various embodiments of the present disclosure may be executed through a sequential, parallel, repetitive or heuristic method. Additionally, some operations may be executed in a different order or may be omitted. Or, other operations may be added.

While the embodiments described herein have been particularly shown and described with reference to specific examples, it will be understood by those of ordinary skill in the art that various changes in form and details may be made therein without departing from the scope of the claimed subject matter as defined by the following claims.

What is claimed is:

1. An electronic device comprising:
a display;
at least one sensor configured to obtain information for determining a user's exercise state; and
at least one processor configured to:
present via the display exercise information set in an exercise program; and
output guide information for exercise based on a comparison between a reference state set in the exercise program and the exercise state.

2. The electronic device of claim 1, wherein
the at least one sensor comprises at least one of a Global Positioning System (GPS) receiver, an acceleration sensor, and an altitude sensor; and
the processor determines at least one of a user's location, speed, and altitude based on information obtained by the at least one sensor.

3. The electronic device of claim 2, wherein the display outputs a map relating to the exercise program and displays the location on the map.

4. The electronic device of claim 1, wherein the exercise program comprises a plurality of exercise sections and the reference state is set differently in the plurality of exercise sections respectively.

5. The electronic device of claim 4, wherein the display displays a progress bar representing a length of an entire exercise routine, and displays the plurality of exercise sections visually distinguished from one another, based on the reference state corresponding to each section.

6. The electronic device of claim 1, wherein the processor presents via the display, in real time, the reference state and a representation of a comparison result of the exercise state based on the reference state.

7. The electronic device of claim 6, wherein when the comparison result is out of a specified range, the processor provides the guide information.

8. The electronic device of claim 7, wherein the guide information is provided through an audio output.

9. The electronic device of claim 1, wherein the processor provides the guide information when a specified point is passed during an entire exercise routine.

10. The electronic device of claim 1, wherein the exercise program comprises a plurality of exercise sections; and the processor provides information on a new exercise section before transitioning to the new exercise section.

11. The electronic device of claim 1, wherein the exercise program comprises a plurality of exercise sections; and the processor provides information on a reference state of a new exercise section when entering the new exercise section.

12. The electronic device of claim 1, wherein the processor provides feedback on a user's current exercise state when a specified time elapses after the guide information is provided.

13. The electronic device of claim 1, wherein the processor performs the comparison periodically according to a specified period.

14. The electronic device of claim 13, wherein the specified period is changed according to an exercise section or a progress state of an exercise program.

15. The electronic device of claim 13, wherein the specified period is restarted when other guide information unrelated to the comparison is provided.

16. An exercise guide providing method performed by an electronic device, the method comprising:
obtaining information for determining a user's exercise state by using at least one sensor;
outputting, to a display, exercise information set in an exercise program; and
providing guide information for exercise based on a comparison between a reference state set in the exercise program and the exercise state.

17. The method of claim 16, wherein the providing of the guide information comprises:
displaying a first symbol corresponding to the reference state; and
displaying a second symbol corresponding to the exercise state at a relative position with respect to the first symbol based on the comparison result.

18. The method of claim 16, wherein the providing of the guide information comprises providing voice guide information when the comparison result is out of a specified range.

19. The method of claim 16, further comprising providing feedback for a current state of the user when a specified time elapses after the guide information is provided.

20. A computer-readable storage medium storing instructions, when being executed, to allow a processor of an electronic device to execute:
obtaining information for determining a user's exercise state by using at least one sensor;
outputting, to a display, exercise information set in an exercise program; and
providing guide information based on a comparison between a reference state set in the exercise program and the exercise state.
